(19) United States
(12) Patent Application Publication
(10) Pub. No.: US 2011/0217567 A1
(43) Pub. Date: Sep. 8, 2011

(54) METHOD FOR THE MANUFACTURE OF A COMPOUND PRODUCT WITH A SURFACE REGION OF A WEAR RESISTANT COATING, SUCH A PRODUCT AND THE USE OF A STEEL MATERIAL FOR OBTAINING THE COATING

(75) Inventor: Odd Sandberg, Uddeholm (SE)

(73) Assignee: Uddeholms Aktiebolag, Hagfors (SE)

(21) Appl. No.: 13/126,030

(22) PCT Filed: Nov. 3, 2009
(86) PCT No.: PCT/SE2009/051242

§ 371 Date: May 10, 2011

(30) Foreign Application Priority Data
Nov. 6, 2008 (SE) 0850068-8

(51) Int. Cl. B32B 15/18; B22F 7/00; B22F 3/15; B22F 3/24; B32B 5/02

(52) U.S. Cl. 428/639; 419/5; 428/685

(57) ABSTRACT

A wear resistant steel material, produced in a powder metallurgical manner, has the following composition in weight-%: and, further, 0.5 to 14 of (V+Nb/2), wherein the contents of N, on one hand, and of (V+Nb/2), on the other hand, are balanced in relation to each other so that the contents of said elements are within a range A, B, G, H, A in a perpendicular plane coordinate system, where the content of N is the abscissa and the content of V+Nb/2 is the ordinate, and where the coordinates for said points are: and max 7 of any of Ti, Zr, and Al; balance essentially only iron and unavoidable impurities. This steel is excellent for obtaining a wear resistant surface region on a substrate of a metallic material by hot isostatic pressing of the steel material of the substrate. Especially when the wear resistant steel is void of Co, the compound body obtained is especially suitable for use in e.g. valves for nuclear power plants.

### TECHNICAL FIELD

The present invention relates to a method for the manufacture of a compound product comprising a substrate of a first metallic material giving the product the necessary strength/resistance, and a coating of a wear resistant steel material applied on a surface region of the substrate.

The present invention also relates to a compound product comprising a substrate of a first metallic material giving the product the necessary strength/resistance, and a coating of a wear resistant steel material applied on a surface region of the substrate.

Further, the invention relates to the use of a powder metallurgically produced steel material with a certain composition.

### PRIOR ART

Within the technology there are often requirements which cannot be fulfilled by a single material. For instance, contemporaneous and incompatible requirements may be put on ductility/toughness and wear resistance. In order to fulfil such requirements so called compound products can be used, wherein two or several bodies of the same or different materials are bound by hot isostatic pressing. A substrate gives the product the necessary strength/resistance while a surface region of the substrate is provided with a coating giving the necessary wear resistance. Such compound products have lead to a common use within e.g. the offshore industry, the food industry, the processing industry, and the pulp industry, where also corrosion resistance is required, e.g. valves, pumps and attachment devices.

For instance valves being used to control the flow of steam and water in nuclear power plants as a rule comprise valve components built up by welding-on with an alloy onto a substrate structure of AISI 316L, i.e. a stainless steel for pressure vessels. During use, the sealing surfaces of the valve are subjected to a slightly abrasive wear and also to cold welding because of high surface pressures and a relative motion between the components, so called galling, which makes it necessary regularly to perform maintenance in the form of grinding, repair welding or exchange of valves.

A steel alloy for building up a sealing surface in the valve is defined by:
Producability
Compatibility in the valve construction
Friction value
Galling behaviour
Resistance to wear
Ductility/toughness
Temperature stability
Resistance to corrosion
Resistance to indentation (i.e. hardness)
Machinability, grindability and polishability
Radiation activity

For instance, in valves for the nuclear power industry, the alloy Stellite 6 (a trademark from Deloro Stellite Company) has generally been a standard material for wear resistant materials. Stellite 6 is a Co—Cr-alloy with 1.3% C, 1.1% Si, 0.1% Mn, 30% Cr, 2.3% Ni, 0.1% Mo, 4.7% W, 2.3% Fe, and retained Co. Stellite 6 is applied on the substrate by manual metallic arc welding, wherein a dendritic austenitic Co-matrix is formed with a high volume of chromium carbides, which are unevenly distributed in the matrix. The coating of Stellite 6 by welding may already from the beginning or during operation cause macroscopic cracking in the sealing surfaces because of the stresses arising during the welding process or during operation. In this way, leakage will occur and a reduced stability due to galling, which results in an increased need of maintenance in an environment with rigid safety requirements. A more optimal coating by welding is the use of laser welding or plasma welding by means of a powder of Stellite 6, wherein cracks and defects are minimized.

It has proved that the friction coefficient of Stellite alloys varies depending on temperature and pressure during operation. At low operation temperatures, ˜20° C., and low pressures, <60 MPa, the friction coefficient is rather high, ˜0.55 to 0.60, while at high pressures, above 100 to 200 MPa, and at operation temperatures above 50 to 80° C., the friction coefficient is markedly lower, ˜0.25. This is explained in such a way that in a first step at a heavy load, a deformation hardening of Stellite 6 takes place where a phase transformation from a face centred cubic (FFC) crystalline structure giving high friction to a hexagonal close packed (HCP) crystalline structure occurs. In a second step a change of layers takes place in the surface, so that some HCP-basic layers become parallel with the surface and in this way creates a structure in which shearing easily occurs. At lower pressures, this second step does not occur.

In many respects, Stellite 6 is an excellent material, but it contributes to increasing the level of the background radiation in the primary circuit in boiling water reactors. This depends on the fact that wear and corrosion release ions of the isotope ⁵⁹Co, which through neutron capture, when it circulates through the primary circuit, is activated to the radioactive isotope ⁶⁰Co, which emits dangerous gamma radiation when decomposing to ⁵⁹Co. Because of this disadvantage, research has been done during the latest decades in order to develop an alloy void of Co, which has good resistance to wear and corrosion and therefore is suitable for use in radioactive environments.

Such alloys, void of Co, are described in e.g. U.S. Pat. No. 4,803,045 and may be applied by welding and have the following composition in weight-%:

| C | Mn | Si | Cr | Ni | Mo | N, | Nb | Ti | Ta | Fe |
|---|---|---|---|---|---|---|---|---|---|---|
| 0.85- | 5-13 | 1.5- | 18-27 | 4-12 | <6 | 0.1-0.3 | <1 | <1 | <1 | balance |
| 1.4 | | 5.5 | | | | | | | | |

The alloys have a microstructure mainly consisting of an austenitic matrix and eutectic alloy carbides.

A further development of said weldable hard welding alloys, which are void of Co, is described in U.S. Pat. No. 5,702,668 and has the following composition in weight-%:

| C | Mn | Si | Cr | Ni | Mo | N | P | S | B | Fe |
|---|---|---|---|---|---|---|---|---|---|---|
| 1.1-1.35 | 4-5 | 3-3.5 | 22.5-26 | 3.7-4.2 | 1.8-2.2 | 0.02-0.18 | <0.018 | <0.01 | <0.002 | balance |

Also these alloys have a microstructure mainly consisting of an austenitic matrix and eutectic alloy carbides.

Other weldable hard welding alloys, which are void of Co, are marketed by Böhler Welding under the trade name Skwam and have the following composition in weight-%:

| | C | Si | Mn | Cr | Mo | Ni | Fe |
|---|---|---|---|---|---|---|---|
| Skwam-IG | 0.2 | 0.65 | 0.55 | 17.0 | 1.1 | 0.4 | balance |
| Fox Skwam | 0.22 | 0.4 | 0.4 | 17.0 | 1.3 | | balance |

As also the hard welding coatings, which are void of Co, are applied by welding, macroscopic cracking in the sealing surfaces may occur already from the beginning or during operation due to the stresses arising during the welding process or during operation, like at the coating of the Stellite. In this way, leakage and a reduced stability due to galling will occur, which results in an increased need of maintenance in an environment with rigid safety requirements.

Further, WO 2007/024192 A1 (Uddeholm Tooling Aktiebolag) describes a powder metallurgically produced steel alloy as well as tools and components made of the alloy. The alloy has the following composition in weight-%: 0.01 to 2 C, 0.6 to 10 N, 0.01 to 3.0 Si, 0.01 to 10.0 Mn, 16 to 30 Cr, 0.01 to 5 Ni, 0.01 to 5.0 (Mo+W/2), 0.01 to 9 Co, max. 0.5 S, and 0.5 to 14 (V+Nb/2), wherein the contents of N, on one hand, and of (V+Nb/2), on the other hand, have been balanced in relation to each other, so that the contents of these elements are in an area defined by the coordinates A′, B′, G, H, A′, where the [N, (V+Nb/2)]-coordinates for these points are: A′: [0.6, 0.5]; B′: [1.6, 0.5]; G: [9.8, 14.0]; H: [2.6, 14.0], as well as max. 7 of any of Ti, Zr and Al, balance essentially only iron and impurities in normal contents. The steel is intended to be used for the manufacture of tools for injection moulding, compression moulding and extrusion of plastic components as well as of cold work tools which are subjected to corrosion. Further, also engineering components, e.g. injection nozzles for engines, wear metal components, pump components, bearing components, etc. An additional application field is the use of the steel alloy for the manufacture of knives for the food industry.

### DISCLOSURE OF THE INVENTION

An object of the invention is to provide a method for the manufacture of a compound product, wherein the application of the hard coating does not take place through welding.

This object is achieved with the method described in the first paragraph by it comprising the following steps, according to the invention:
production of a wear resistant steel material in a powder metallurgical manner with the following composition in weight-%:

| C | Si | Mn | Cr | Ni | Mo + W/2 | Co | S | N |
|---|---|---|---|---|---|---|---|---|
| 0.01-2 | 0.01-3.0 | 0.01-10.0 | 16-33 | max. 5 | 0.01-5.0 | max. 9 | max. 0.5 | 0.6-10 |

and, further,
0.5 to 14 of (V+Nb/2), where the contents of N, on one hand, and of (V+Nb/2), on the other hand, are balanced such in relation to each other that the contents of said elements are within an area A′, B′, G, H, A′ in a perpendicular, plane coordinate system, where the content of N is the abscissa and the content of V+Nb/2 is the ordinate and where the coordinates for said points are:

| | A′ | B′ | G | H |
|---|---|---|---|---|
| N | 0.6 | 1.6 | 9.8 | 2.6 |
| V + Nb/2 | 0.5 | 0.5 | 14.0 | 14.0 |

and
max 7 of any of Ti, Zr, and Al,
balance essentially only iron and unavoidable impurities;
application of the wear resistant steel material on said surface region of the substrate; and
hot isostatic pressing of the substrate with the coating to an completely dense or at least close to completely dense body.

An object bound to the above object is to provide a compound product, in which a wear surface fulfils high requirements for resistance against wear and corrosion and also in an embodiment, which is void of Co, escapes macroscopic cracking.

This object is achieved with the compound product according to the invention mentioned in the second paragraph above, in that
it comprises a substrate material for a wear surface, where the substrate has a first composition;
the wear surface comprises a wear resistant steel material with a second composition, which comprises, in weight-%:

| C | Si | Mn | Cr | Ni | Mo + W/2 | Co | S | N |
|---|---|---|---|---|---|---|---|---|
| 0.01-2 | 0.01-3.0 | 0.01-10.0 | 16-33 | max. 5 | 0.01-5.0 | max. 9 | max. 0.5 | 0.6-10 |

and, further,
0.5 to 14 of (V+Nb/2), wherein the contents of N, on one hand, and of (V+Nb/2), on the other hand, are balanced in relation to each other so that the contents of said elements are in an area A′, B′, G, H, A′ in a perpendicular, plane coordinate system, where the content of N is the abscissa and the content of V+Nb/2 is the ordinate, and where the coordinates for said points are:

| | A′ | B′ | G | H |
|---|---|---|---|---|
| N | 0.6 | 1.6 | 9.8 | 2.6 |
| V + Nb/2 | 0.5 | 0.5 | 14.0 | 14.0 |

and
max 7 of any of Ti, Zr, and Al,
balance essentially only iron and unavoidable impurities;
the wear resistant steel material has a microstructure comprising an even distribution of up to 50 vol.-% of hard phase particles of M₂X-, MX- and/or M₂₃C₆/M7C3-type, the sizes of which in their longest extension are 1 to 10 μm, wherein the content of these hard phase particles is distributed in such a way that up to 20 vol.-% are M₂X-carbides, -nitrides and/or -carbonitrides, where M mainly is V and Cr, and X mainly is N, as well as 5 to 40 vol.-% of MX-carbides, -nitrides and/or -carbonitrides, where M mainly is V and X mainly is N, wherein the average size of these MX-particles is below 3 μm, preferably below 2 μm, and even more preferred below 1 μm.

As the wear resistant coating is not applied through welding, one avoids that macroscopic cracking in the sealing surfaces arises already from the beginning or during operation due to the stresses arising during the welding process or during operation. In this way, the risk of leakage and reduced stability due to galling are minimized, which gives the advantage of a reduced need of expensive maintenance in an environment with rigid safety requirements. Thanks to the fact that the wear resistant material has a composition as mentioned above, which is balanced regarding the content of nitrogen in relation to the content of vanadium and possibly occurring niobium, a wear resistant surface layer may be obtained on the compound product. As the microstructure has a high content of very hard, stable hard phase particles, a wear surface may be achieved which easily fulfils very high requirements for anti-galling and anti-fretting properties at the same time as it has very good properties against corrosion.

Another object connected to the above objects is to achieve a new application for the above known powder metallurgically produced steel alloy.

This object is achieved by a steel material of the present invention having the following composition in weight-%:

| C | Si | Mn | Cr | Ni | Mo + W/2 | Co | S | N |
|---|---|---|---|---|---|---|---|---|
| 0.01-2 | 0.01-3.0 | 0.01-10.0 | 16-33 | 0.01-5 | 0.01-5.0 | max. 9 | max. 0.5 | 0.6-10 |

and, further,

0.5 to 14 of (V+Nb/2), wherein the contents of N, on one hand, and of (V+Nb/2), on the other hand, are balanced in relation to each other so that the contents of said elements are in an area A′, B′, G, H, A′ in a perpendicular, plane coordinate system, where the content of N is the abscissa and the content of V+Nb/2 is the ordinate, and where the coordinates for said points are:

| | A′ | B′ | G | H |
|---|---|---|---|---|
| N | 0.6 | 1.6 | 9.8 | 2.6 |
| V + Nb/2 | 0.5 | 0.5 | 14.0 | 14.0 |

and

max 7 of any of Ti, Zr, and Al,

balance essentially only iron and unavoidable impurities;

being used to achieve a wear resistant surface region on a substrate of a metallic material with another first composition, wherein said surface region preferably is a wear surface of a valve, e.g. a valve in a nuclear power plant, more specifically a valve in the primary circuit of a nuclear power plant.

In this way, it will be possible to use the powder metallurgically produced steel material for products requiring very good wear resistance in the surface region of the product at the same time as the product preferably fulfils requirements for corrosion resistance, workability, ductility, machinability, hardness, hot treatment response both regarding substrate and wear layer.

Additional characteristic features of the different embodiments of the invention and what is obtained therewith will be apparent from the following detailed description and from the claims.

### BRIEF DESCRIPTION OF THE ENCLOSED DRAWINGS

Below, the invention will be described more in detail with reference to preferred embodiments and to the enclosed drawings.

FIG. 1 is a microstructure photo taken with an electron microscope over a binding region between a substrate of AISI 3161 and the hard coating of Vanax 75 (according to the invention) after hot isostatic pressing.

FIG. 2 is a graph showing the contents of vanadium, chromium, nickel, and manganese in a compound product at the passage from a substrate of AISI 316L via a capsule wall of nickel to the hard coating of Vanax 75 (according to the invention) after hot isostatic pressing.

FIG. 3 is a graph showing the contents of carbon and nitrogen in a compound product at the passage from a substrate of AISI 316L via a capsule wall of nickel to the hard coating of Vanax 75 (according to the invention) after hot isostatic pressing.

FIG. 4 is a graph showing the analyzed composition of the steel material at the passage from a substrate of AISI 316L via a capsule wall of nickel to the hard coating of Vanax 75 (according to the invention) after hot isostatic pressing.

FIG. 5 shows the proportion between the content of N and the content of (V+Nb/2) for the steel used, in the form of a coordinate system.

FIG. 6 is a graph comparing the wear resistance for the three alloys tested.

FIG. 7 is a graph comparing the corrosion resistance for the three alloys tested.

FIG. 8 shows the microstructure of a wear resistant layer made of a powder metallurgically produced steel material which has been hot isostatically pressed, and then heat treated according to a preferred embodiment of the invention.

FIG. 9 shows the microstructure of a wear resistant layer produced by welding-on with Stellite 6 (reference material).

FIG. 10 shows the microstructure of a wear resistant layer produced by welding-on with Skwam (reference material).

FIG. 11 is a graph showing the friction properties of Stellite 6.

FIG. 12 is a graph showing the friction properties of Skwam.

FIG. 13 is a graph showing the friction properties of Vanax 75.

FIG. 14 is a graph showing the friction properties of Vanax 75 as compared to Stellite 6.

FIG. 15 is a graph comparing the hardness in relation to the tempering temperature between the wear resistant steel material according to the invention and Stellite 6.

FIG. 16 is a graph comparing the machinability between the wear resistant steel material according to the invention and Stellite 6.

### DETAILED DESCRIPTION OF PREFERRED EMBODIMENTS

Manufacture of a Compound Product

According to the method of the invention for the production of a compound product, the wear resistant steel material is applied on a surface region of a substrate of a first metallic material, which will give the compound product the necessary strength/resistance. The product obtained in this way is hot isostatically pressed to a completely dense or at least close to completely dense body.

According to a first preferred embodiment of the method, an insert of the first metallic material, i.e. the substrate, is put into the capsule, and a powder of the wear resistant steel material is applied on said surface region of the insert. Thereafter, the capsule is sealed and gas is evacuated, and the capsule with its content is thereafter hot isostatically pressed to a completely dense or at least close to completely dense body.

According to a second preferred embodiment of the method, the powder of the wear resistant steel material is applied on a surface region of an insert of the first metallic material, which insert is at least to some extent completely machined, i.e. the substrate. A hood-like capsule is welded to the insert so that the powder is encased in the hood-like capsule against the surface region. For instance, this may be performed in such a way that the powder is filled into a hood-like capsule which is placed with its open part against the surface region of the insert, so that the powder will abut against the insert, and subsequently the welding of the hood-like capsule and the evacuation of gas in the hood-like capsule is performed. Another way to apply the powder on the wear surface may be to mechanically fasten the powder to the wear surface. Also the application of the powder by using any suitable binder is conceivable. By applying the powder to the wear surface a powder layer may be built up, which layer is not completely dense but which is durable enough to withstand the treatment necessary in connection with the hot isostatic pressing. The powder layer may then be pressed to a completely dense or at least close to completely dense condition through hot isostatic pressing. No encasing capsule is needed for this method.

According to a third preferred embodiment of the method, an intermediate product of the wear resistant steel material is manufactured by binding the powder granules together in the powder of the wear resistant steel material, and this intermediate product is applied on an insert of the first metallic material, i.e. the substrate. Subsequently the unit obtained is encased in the capsule. The powder granules are bound together by sintering or hot isostatic pressing, and the body obtained may also be subjected to some kind of hot working, e.g. forging. An additional working for obtaining a suitable shape, e.g. a strip, ring or disc shape, is, of course, also possible.

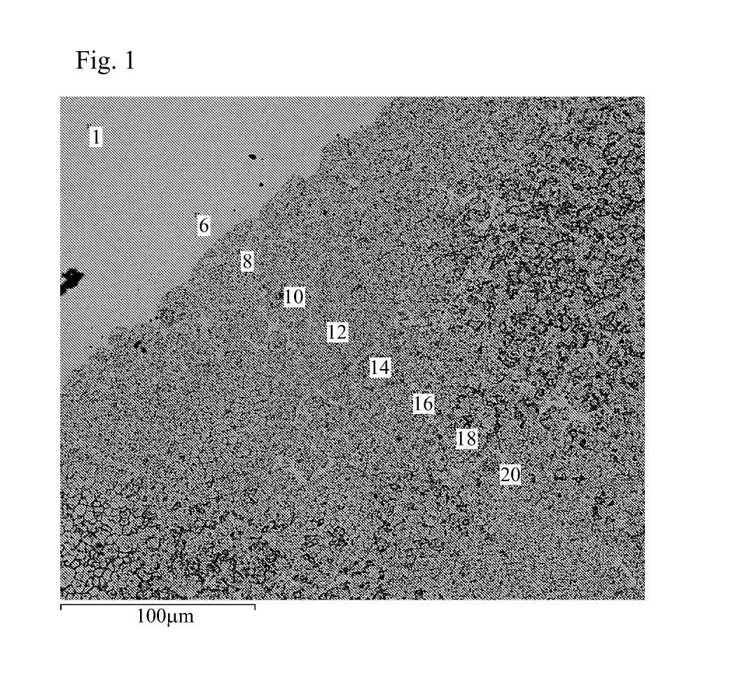

FIG. 1 shows a microstructure photo taken with an electron microscope over a binding region between the substrate material 1 and the wear resistant steel material 2 after hot isostatic pressing. The binding 3 is clearly seen as an almost sharp line between the two materials. The contents of the alloy elements vanadium, chromium, manganese, nickel, carbon, and nitrogen have been analyzed at even intervals along an imaginary line from the substrate material 1 (points 1 to 5) via the binding 3 (points 6 to 8) and further into the wear resistant steel material 2 (points 9 to 20).

FIG. 2 is a graph showing the contents of the alloy elements vanadium, chromium, manganese, nickel. The measurement shows that the contents of all elements are on level with the substrate material. The variations of the contents of vanadium and chromium in the wear resistant steel material may be assigned to the occurrence of hard phase particles in the material.

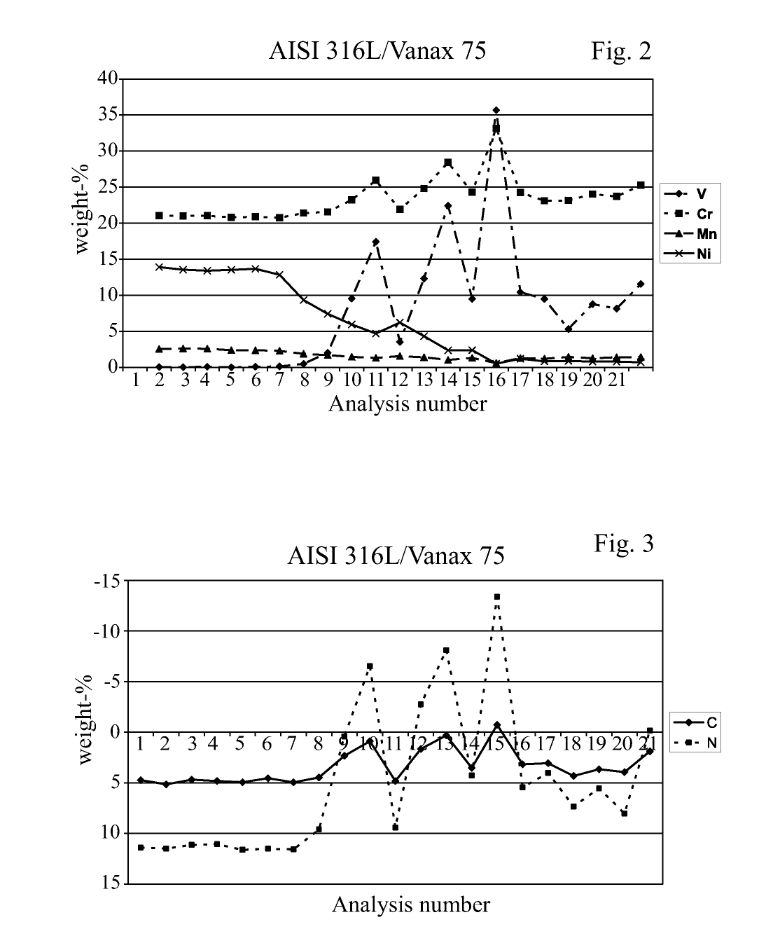

FIG. 3 shows how the contents of carbon and nitrogen vary along the test line and it is obvious that neither the content of carbon nor nitrogen has changed in the substrate material. This is to be regarded as very positive, as both carbon and nitrogen are elements which are very mobile as they dissolve interstitially, and therefore it was feared that they would diffuse into the substrate material. Such diffusion would be very serious, as both carbon and nitrogen would bind chromium in the first place and form chromium carbides in the grain boundaries. In this way, the substrate material is depleted of chromium, and there are risks for inter-crystalline corrosion.

As a harmful diffusion between the wear resistant steel material and the first metallic material would take place at the hot isostatic pressing, it is suitable that the two steel materials are kept apart by a diffusion barrier in the form of a capsule wall. Such a capsule wall preferably consists at least mainly of nickel or a monel metal and may have a thickness of 1 mm. At the hot isostatic pressing, it is unsuitable if carbon and nitrogen diffuse into the substrate material, if it is a stainless steel, as the stainless steel would then be susceptible to inter-crystalline corrosion.

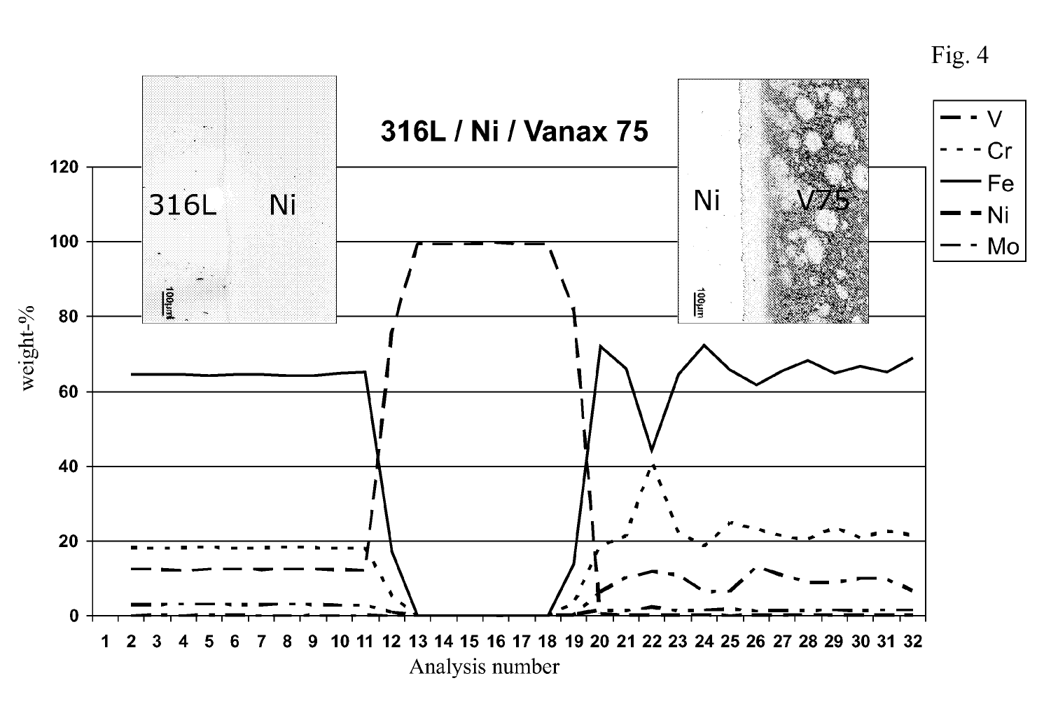

FIG. 4 is a graph showing the contents of certain critical alloy elements at the passage from a substrate of AISI 3161 (analysis points Nos. 1 to 199) via a capsule wall of nickel (analysis points Nos. 12 to 19) to a hard coating of Vanax 75, according to the invention, (analysis points Nos. 20 to 32) after hot isostatic pressing. The somewhat uneven graphs in the Vanax 75 phase adjacent to the nickel phase may be attributed to hard phase particles.

According to a fourth preferred embodiment of the method, the substrate is manufactured simultaneously with the application of the wear resistant coating. This may take place by an inner capsule being filled with powder of the steel material which shall give the substrate the necessary strength/resistance. This capsule is sealed, evacuated of gas and positioned in an outer capsule, in which the powder of the wear resistant steel is put/has been put. It is realized that the amount of powder of the respective steel material and the mutual location of the inner capsule and the powder of the wear resistant steel material, respectively, is dependent on several factors, e.g. the shape of the desired compound product, the thickness of the wear layer, the thickness of the substrate and the volume change (contraction) at the pressing, and must be adapted to these factors. Thereafter, the outer capsule is sealed and evacuated of gas, and the entire unit is hot isostatically pressed. An alternative method according to this fourth embodiment is not to use an inner capsule but instead to fill powders of the various steel materials into a common capsule, where the powders of the various steel materials are put into a suitable place in the capsule to achieve a compound product according to the invention, i.e. a substrate with a wear surface comprising a wear resistant steel material.

The hot isostatic pressing is suitably performed during a period of 3 h at 1000 to 1350° C., preferably 1100 to 1150° C. and at a pressure of 100 MPa.

In all cases, said steps are followed by soft annealing and machining to the desired dimensions. Subsequently, the heat treatment follows, preferably by hardening from an austenitizing temperature of 950 to 1150° C. and low temperature tempering at 200 to 450° C., 2×2 h, or high temperature tempering at 450 to 700° C., 2×2 h. Suitable temperatures are chosen to achieve the desired properties of the wear surface consisting of the wear resistant steel material, which is discussed in detail below.

Further, in all cases, a metallic material of the substrate is chosen that withstands hot isostatic pressing at 1100 to 1150° C., and further, it is important that the substrate material is chosen such that it has hot working properties which are compatible with the wear resistant steel material. In compound products for valves, it is suitable that the substrate consists of a steel with desired properties as to corrosion, ductility and hardness and which fulfils the criterions of pressure vessels, should the occasion arise. As examples, ferritic, austenitic or ferrit-austenitic materials of the stainless segment may be mentioned, and examples of such materials are AISI 3161, AISI 304. A substrate material of AISI 316L, for instance, is compatible for heat treatment in the temperature range 1050 to 1100° C., when quench annealing of the AISI 316L material takes place. For other, less demanding applications, also other materials may be chosen, e.g. carbon steel, steels for pressure vessels, tool steels, cast iron, and also brass or copper, wherein a diffusion barrier of e.g. nickel or a monel metal shall be used, if required.

Within the scope of this invention, the term “coating” relates to the fact that the coating is a thin surface layer as compared to the substrate, i.e. the thickness of the material of the substrate by far exceeds the thickness of the coating. However, the term also relates to the fact that the thickness of the coating is essentially similar to the thickness of the substrate. In exceptional cases, where the circumstances so require, e.g. where the part of the product which is subjected to wear will be a protruding portion and the substrate is an attachment portion, it is realized that the coating of the wear resistant steel material will be the main part of the compound product, and the term coating thus comprises also a material thickness of the wear resistant steel material that is considerably thicker than the thickness of the substrate material. Within the scope of the invention, the coating may thus have a thickness of 0.5 to 1000 mm, but in most applications the thickness most likely will not exceed 50 mm, and even more likely the thickness does not exceed 30 mm. In most cases the coating will have a thickness of 0.5 to 10 mm, more preferred 3 to 5 mm.

In a particularly preferred embodiment of the invention, where the compound product is a component in a valve which is subjected to wear and the material of the substrate consists of a steel for pressure vessels, it is then suitable that the wear resistant steel material is void of intentionally added cobalt and forms a wear surface of a component in a valve in a nuclear power plant, which component is subjected to wear, and that the material of the substrate has a composition corresponding to AISI 316L. The valve has a diameter of 100 mm and a length of 50 to 150 mm. The thickness of the wear layer after hot isostatic pressing, machining and possible grinding to a necessary surface finish is 0.5 to 200 mm, preferably 3 to 5 mm.

As the wear resistant coating is not applied through welding, it is possible to avoid that macroscopic cracking in the sealing surfaces arises already from the beginning or during operation due to the stresses arising during the welding process or during operation. In this way, the risk of leakage and a reduced stability due to galling are minimized, which gives the advantage of a reduced need of expensive maintenance in an environment with rigid safety requirements.

The Steel Material

The steel material used as the wear resistant layer according to the invention is powder metallurgically manufactured, which is a condition for the steel being, to a great extent, void of oxide inclusions and obtaining a microstructure comprising an even distribution of up to 50 vol.-% of hard phase particles of M₂X—, MX— and or M₂₃C₆/M₇C₃ type, the size of which in their longest extension is 1 to 10 μm, wherein the content of said hard phase particles are distributed in such a way that up to 20 vol.-% are M₂X-carbides, -nitrides and/or -carbonitrides, wherein M mainly is V and Cr, and X mainly is N, and 5 to 40 vol.-% of MX-carbides, -nitrides and/or -carbonitrides, wherein M mainly is V, and X mainly is N, wherein the average size of said MX-particles is below 3 μm, preferably below 2 μm, and even more preferred below 1 μm. Preferably, the powder metallurgical manufacturing comprises gas atomizing of a steel melt with nitrogen as the atomizing gas, which gives the steel alloy a certain minimum content of nitrogen. By solid phase nitriding of the powder, a higher, desirable nitrogen content may be obtained.

The following is valid for the alloy elements of the steel.

In the first place, carbon shall be present in the steel of the invention in a sufficient amount in order to, together with nitrogen in a solid solution in the matrix of the steel, contribute to giving the steel a high hardness of up to 60 to 62 HRC in its hardened and tempered condition. Together with nitrogen, carbon may also be present in primarily precipitated M₂X-nitrides, -carbides, and/or -carbonitrides, wherein M mainly is V and Cr, and X mainly is N, as well as in primarily precipitated MX-nitrides, -carbides and/or -carbonitrides, wherein M mainly is V, and X mainly is N, as well as in possibly occurring M₂₃C₆- and/or M₇C₃-carbides.

Carbon shall together with nitrogen give the desired hardness and form hard phases included into the steel. The content of carbon in the steel, i.e. carbon which is in solid solution in the matrix of the steel plus the carbon which is bound in carbides and/or carbonitrides, shall be held at as low a level as may be motivated for reasons of production economy as well as for reasons of desired phases in the microstructure of the steel material. The steel shall be able to austenitize and be transformable to martensite at the hardening. When necessary, the material is deep frozen to avoid retained austenite. Preferably, the carbon content shall be at least 0.01%, even more preferred at least 0.05%, and most preferred at least 0.1%. The maximum carbon content may be allowed to max. 2%. Depending on the field of application, the carbon content is adapted to the amount of nitrogen in the steel as well as to the total content of the carbide forming elements vanadium, molybdenum and chromium in the steel, in the first place, so that the steel gets a content of M₂X-carbides, -nitrides and/or -carbonitrides of up to 20 vol.-% as well as a content of MX-carbides, -nitrides and/or -carbonitrides of 5 to 40 vol.-%. M₂₃C₆- and/or M₇C₃-carbides may be present in contents up to 8 to 10 weight-%, mainly at very high chromium contents. The total content of MX-, M₂X- and/or M₂₃C₆/M₇C₃-carbides, -nitrides and/or -carbonitrides in the steel shall, however, not exceed 50 vol.-%. Furthermore, the presence of additional carbides in the steel shall be minimized so that the content of dissolved chromium in the austenite is not below 12%. Preferably, the content of dissolved chromium in the austenite is at least 13%, and even more preferred at least 16%, which ensures that the steel obtains a good corrosion resistance.

Nitrogen is an essential alloy element in the steel of the invention. Like carbon, nitrogen shall be present in solid solution in the matrix of the steel to give the steel an adequate hardness and to form the desired hard phases. Preferably, nitrogen is used as an atomizing gas at the powder metallurgical manufacturing process of the metal powder. With such a powder production, the steel will contain max. 0.2 to 0.3% nitrogen. This metal powder may then be given a desired nitrogen content according to any known technique, e.g. by pressurizing in nitrogen gas or by solid phase nitriding of the manufactured powder, and therefore the steel suitably contains at least 0.6%, preferably at least 0.8%, and even more preferred at least 1.2% nitrogen. As pressurizing in nitrogen gas or solid phase nitriding is used, it is, of course, also possible to allow the atomizing to take place with another atomizing gas, e.g. argon.

In order not to cause brittleness problems and give retained austenite, the nitrogen content is maximized to 10%, preferably 8%, and even more preferred max. 6%. As vanadium, but also other strong nitride/carbide formers, e.g. chromium and molybdenum, has a tendency to react with nitrogen and carbon, the carbon content should at the same time be adapted to said high nitrogen content, so that the carbon content is maximized to 2%, suitably max. 1.5%, preferably max. 1.2% for the nitrogen contents mentioned above. In this connection it should, however, be noticed that the corrosion resistance decreases with increased carbon content and that also the galling resistance may decrease, which is a disadvantage, above all because comparatively large chromium carbides, M₂₃C₆ and/or M₇C₃, may be formed as compared to the steel of the invention being given a lower carbon content than the highest contents mentioned above.

In those cases when it is sufficient that the steel has lower nitrogen content, it is therefore desirable to reduce the carbon content too. Preferably, the carbon content is limited to such low levels as may be motivated for reasons of economy, but according to the invention the carbon content may be varied at a certain nitrogen content, wherein the content of hard phase particles in the steel and its hardness may be adapted depending on the field of application, for which the steel is intended. At certain contents of the corrosion inhibiting alloy elements, chromium and molybdenum, nitrogen also contribute to promote the formation of MX-carbonitrides and to suppress the formation of M₂₃C₆ and/or M₇C₃ which reduce the corrosion resistance of the steel in an unfavourably way.

Silicon is present as a residual from the manufacture of the steel and may occur in a minimal content of 0.01%. At high contents, silicon gives a solution hardening effect, but also a certain brittleness. Silicon also is a stronger ferrite former and must therefore not be present in amounts exceeding 3.0%. Preferably, the steel does not contain more than max. 1.0% silicon, suitably max. 0.8%. A nominal silicon content is 0.3%.

Manganese contributes to giving the steel good hardenability. To avoid brittleness problems, manganese must not be present in contents exceeding 10.0%. Preferably, the steel does not contain more than max. 5.0% manganese, suitably max. 2.0% manganese. In embodiments where the hardenability is not of as great importance, manganese is present in the steel in low contents as a retained element from the production of the steel and binds the amounts of sulphur which may be present by forming manganese sulphide. Manganese should therefore be present in a content of at least 0.01% and a suitable manganese range is 0.2 to 0.4%.

Chromium shall be present in a minimum content of 16%, preferably 17%, and even more preferred at least 18%, to give the steel the desired corrosion resistance. Chromium also is an important nitride former and shall as such en element be present in the steel to, together with nitrogen, give the steel an amount of hard phase particles, which contribute to giving the steel the desired galling and wear resistance. Of said hard phase particles, up to 20 vol.-% may consist of M₂X-carbides, -nitrides and/or -carbonitrides, where M mainly is Cr but also a certain amount of V, Mo and Fe, and 5 to 40% may consist of MX-carbides, -nitrides and/or -carbonitrides, where M mainly is V. However, chromium is a strong ferrite former. In order to avoid ferrite after hardening, the chromium content must not exceed 33%, suitably it amounts to max. 30%, preferably max. 27%, and even more preferred max. 25%.

Nickel is an optional element and may us such possibly be present as an austenite stabilizing element in a content of max. 5.0% and suitably max. 3.0% to balance the high contents of the ferrite forming elements chromium and molybdenum in the steel. Preferably, the steel of the invention, however, contains no intentionally added amount of nickel. However, nickel may be tolerated as an unavoidable impurity, which as such may be as high as about 0.8%.

Cobalt also is an optional element and may as such possibly be present in a content of max. 9% and suitably max. 5% in order to improve the tempering response. In hard coatings in e.g. valves for the nuclear power plants and other applications where radioactivity occurs, the steel should, however, not contain any cobalt.

Molybdenum should be present in the steel, as it contributes to giving the steel the desired corrosion resistance, especially good fretting resistance. However, molybdenum is a strong ferrite former, and therefore the steel must not contain more than max. 5.0%, suitably max. 4.0%, preferably max. 3.5% Mo. A nominal molybdenum content is 1.3%.

Molybdenum may principally completely or partly be replaced by tungsten, which does not, however, give the same improvement of the corrosion resistance. Further, twice as much tungsten as molybdenum is required, which is a disadvantage. In addition, also the scrap metal treatment is more difficult.

Vanadium shall be present in the steel in a content of 0.5 to 14%, suitably 1.0 to 13%, preferably 2.0 to 12%, in order to, together with nitrogen and existing carbon, form said MX-nitrides, -carbides, and/or -carbonitrides. According to a first preferred embodiment of the invention the vanadium content is in the range 0.5 to 1.5%. According to a second preferred embodiment, the vanadium content is in the range 1.5 to 4.0, preferably 2.0 to 3.5, and even more preferred 2.5 to 3.0%. A nominal vanadium content according to said second preferred embodiment is 2.85%. According to a third preferred embodiment, the vanadium content is in the range 4.0 to 7.5, preferably 5.0 to 6.5, and even more preferred 5.3 to 5.7%. A nominal vanadium content according to said third preferred embodiment is 5.5%. According to a fourth preferred embodiment, the vanadium content is in the range 7.5 to 11.0, preferably 8.5 to 10.0, and even more preferred 8.8 to 9.2%. A nominal vanadium content according to said fourth preferred embodiment is 9.0%. Within the scope of the invention idea, it is also conceivable to allow vanadium contents of up to about 14% in combination with nitrogen contents of up to about 10% and carbon contents in the range 0.1 to 2%, which gives the steel the desired properties, especially at the use as hard material coatings in moulding and cutting tools with high requirements for corrosions resistance in combination with high hardness (up to 60 to 62 HRC) and a moderate ductility as well as extremely high requirements for wear resistance (abrasive/adhesive/galling/fretting).

In principle, vanadium may be replaced by niobium to form MX-nitrides, -carbides and/or -carbonitrides, but in such a case a larger amount is required as compared to vanadium, which is a disadvantage. Further, niobium results in the nitrides, carbides and/or carbonitrides getting a more edged shape and being larger than pure vanadium nitrides, carbides and/or carbonitrides, which may initiate ruptures or chippings and hence reduce the toughness and the polishability of the material. This may be especially detrimental for the steel in those cases when the composition is optimized in order to achieve an excellent wear resistance in combination with good ductility and high hardness, as regards the mechanical properties of the material. In this case, the steel must not contain more than max. 2%, suitably max. 0.5%, preferably max. 0.1% niobium. As to production, there are also problems, as Nb(C,N) may give clogging of the tapping jet from the ladle during the atomizing. According to said first embodiment, the steel must therefore not contain more than 6%, preferably it amounts to max. 2.5%, suitably max. 0.5% niobium. In the most preferred embodiment, niobium is not tolerated more than as an unavoidable impurity in the form of a retained element emanating from the raw metal materials at the manufacture of the steel.

In addition to said alloy elements, the steel need not, and should not, contain any additional alloy elements in significant amounts. Certain elements are expressively undesired, as they influence the properties of the steel in an undesired manner. This is true for e.g. phosphorus, which should be held at as low a level as possible, preferably max. 0.03%, in order not to influence the toughness of the steel in a negative manner. Also sulphur is in most cases an undesired element, but its negative influence on the toughness, above all, may essentially be neutralized by means of manganese, which forms essentially harmless manganese sulphides and may therefore be tolerated in a maximal content of 0.5% in order to improve the machinability of the steel. Titanium, zirconium and aluminium are also in most cases undesired but may together be allowed in a maximal amount of 7%, but normally in considerably lower contents, <0.1% in all.

As mentioned, the nitrogen content shall be adapted to the content of vanadium and possibly occurring niobium in the material to give the steel an amount of 5 to 40 vol.-% of MX-carbides, -nitrides and/or -carbonitrides. The conditions for the proportions between N and (V+Nb/2) are shown in FIG. 1, which shows the content of N related to the content (V+Nb/2) for the steel of the invention. The corner points in the areas shown have coordinates according to the table below:

TABLE 1
the proportions between N and (V + Nb/2)

| | N | V + Nb/2 |
|---|---|---|
| A | 0.8 | 0.5 |
| A′ | 0.6 | 0.5 |
| B | 1.4 | 0.5 |
| B′ | 1.6 | 0.5 |
| C | 8.0 | 14.0 |
| D | 4.3 | 14.0 |
| E | 1.9 | 1.5 |
| E′ | 3.1 | 4.0 |
| E″ | 4.8 | 7.5 |
| E′″ | 6.5 | 11.0 |
| F | 2.2 | 1.5 |
| F′ | 3.7 | 4.0 |
| F″ | 5.8 | 7.5 |
| F′″ | 8.0 | 11.0 |
| G | 9.8 | 14.0 |
| H | 2.6 | 14.0 |
| I | 0.7 | 1.5 |
| I′ | 1.1 | 4.0 |
| I″ | 1.6 | 7.5 |
| I′″ | 2.1 | 11.0 |
| J | 1.1 | 1.5 |
| J′ | 1.7 | 4.0 |
| J″ | 2.6 | 7.5 |
| J′″ | 3.5 | 11.0 |

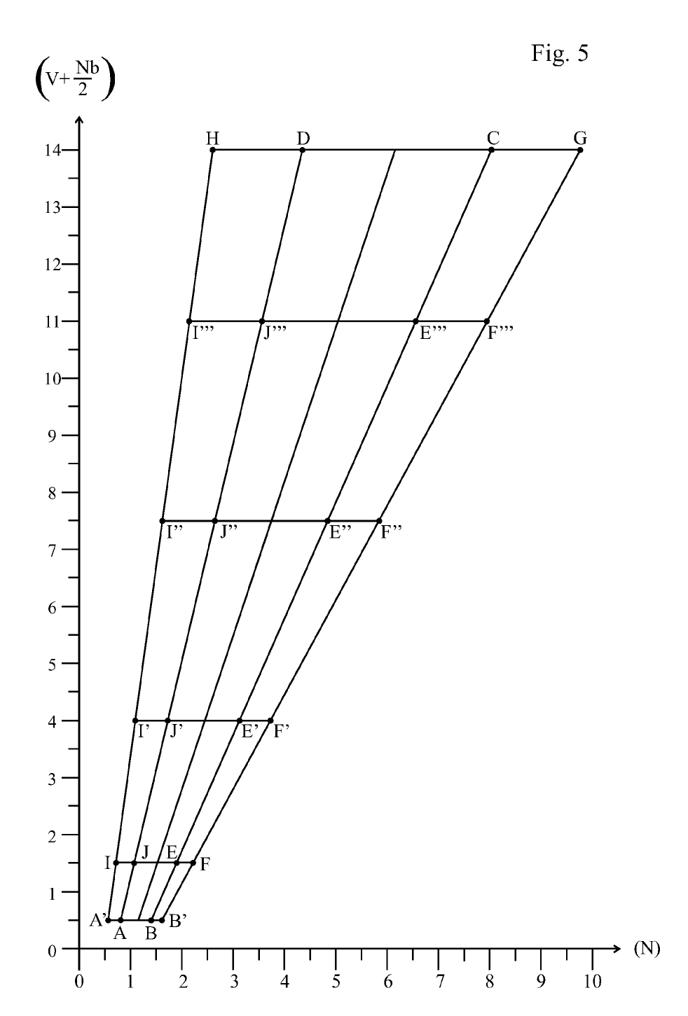

According to a first aspect of the steel used according to the invention, the content of N, on one hand, and of (V+Nb/2), on the other hand, shall be so balanced in relation to each other that the contents of these elements are within a region defined by the coordinates A′, B′, G, H, A′ in the coordinate system of FIG. 5.

According to a first preferred embodiment of the invention, the contents of nitrogen, vanadium and possibly occurring niobium in the steel shall be so balanced in relation to each other that the contents are within the region defined by the coordinates A′, B′, F, I, A′, and more preferred within A, B, E, J, A.

According to a second preferred embodiment of the invention, the contents of nitrogen, vanadium and possibly occurring niobium in the steel shall be so balanced in relation to each other that the contents are within the range defined by the coordinates I, F, F′, I′, I, and more preferred within E, E′, J′, J, E.

According to a third preferred embodiment of the invention, the contents of nitrogen, vanadium and possibly occurring niobium in the steel shall be so balanced in relation to each other that the contents are within the range defined by the coordinates I′, F′, F″, I″, I′, and more preferred within E′, E″, J″, J′, E′.

According to a fourth preferred embodiment of the invention, the contents of nitrogen, vanadium and possibly occurring niobium in the steel shall be so balanced in relation to each other that the contents are within the range defined by the coordinates I″, F″, F′″, I′″, I″, and more preferred within J″, E″, E′″, J′″, J″.

Table 2 shows the composition ranges in weight-% for a steel according to the first preferred embodiment of the invention.

TABLE 2

| | Element | | | | | | |
|---|---|---|---|---|---|---|---|
| | C | Si | Mn | Cr | Mo | V | N |
| Min. | 0.10 | 0.01 | 0.01 | 18.0 | 0.01 | 0.5 | 0.8 |
| Guideline value | 0.20 | 0.30 | 0.30 | 21.0 | 1.3 | 1.0 | 0.95 |
| Max. | 0.50 | 1.5 | 1.5 | 21.5 | 2.5 | 2.0 | 2.0 |

Table 3 shows the composition ranges in weight-% for a steel according to the second preferred embodiment of the invention.

TABLE 3

| | Element | | | | | | |
|---|---|---|---|---|---|---|---|
| | C | Si | Mn | Cr | Mo | V | N |
| Min. | 0.10 | 0.01 | 0.01 | 18.0 | 0.01 | 2.0 | 1.3 |
| Guideline value | 0.20 | 0.30 | 0.30 | 21.0 | 1.3 | 2.85 | 2.1 |
| Max. | 0.50 | 1.5 | 1.5 | 21.5 | 2.5 | 4.0 | 3.0 |

Preferably, the content of V is between 2.5 and 3.0 weight-% and the content of N between 1.3 and 2.0 weight-%. As an illustrative example, a complete analysis of such a steel, including impurities, may give the following composition in weight-%:

TABLE 4

| C | Si | Mn | P | S | Cr | Ni | Mo | W | Co |
|---|---|---|---|---|---|---|---|---|---|
| 0.18 | 0.34 | 0.38 | 0.007 | 0.006 | 20.1 | 0.009 | 1.32 | 0.003 | 0.009 |
| V | Ti | Nb | Cu | Sn | Al | N | B | Ca: | Mg |
| 2.87 | 0.006 | 0.002 | 0.005 | 0.002 | 0.001 | 1.65 | 0.0001 | 0.0005 | 0.00010 |

The steel according to the second embodiment is suitable to use where high requirements for corrosion resistance in combination with high hardness (up to 60 to 62 HRC) and good ductility as well as increasing demands for resistance against both abrasive and adhesive wear as well as galling and fretting applies. With a composition according to the table, the steel has a matrix, which after hardening from an austenitizing temperature of 950 to 1150° C. and low temperature tempering at 200 to 450° C., 2×2 h, or high temperature tempering at 450 to 700° C., 2×2 h, consists of tempered martensite with a hard phase amount consisting of up to about 10 vol.-% each of M₂X, where M mainly is Cr, and X mainly is N, and of MX, where M mainly is V and Cr, and X mainly is N.

Table 5 shows the composition ranges in weight-% for a steel according to the third preferred embodiment of the invention.

TABLE 5

| | Element | | | | | | |
|---|---|---|---|---|---|---|---|
| | C | Si | Mn | Cr | Mo | V | N |
| Min. | 0.10 | 0.01 | 0.01 | 18.0 | 0.01 | 4.0 | 1.5 |
| Guideline value | 0.20 | 0.30 | 0.30 | 21.0 | 1.3 | 5.5 | 3.0 |
| Max. | 0.80 | 1.5 | 1.5 | 21.5 | 2.5 | 7.5 | 5.0 |

Table 6 shows the composition ranges in weight-% for a steel according to the fourth preferred embodiment of the invention.

TABLE 6

| | Element | | | | | | |
|---|---|---|---|---|---|---|---|
| | C | Si | Mn | Cr | Mo | V | N |
| Min. | 0.10 | 0.01 | 0.01 | 18.0 | 0.01 | 7.5 | 2.5 |
| Guideline value | 0.20 | 0.30 | 0.30 | 21.0 | 1.3 | 9.0 | 4.3 |
| Max. | 1.5 | 1.5 | 1.5 | 21.5 | 2.5 | 11 | 6.5 |

The steel according to the fourth embodiment is suitable to use for wear surfaces of products with high requirements for corrosion resistance in combination with high hardness (up to 60 to 62 HRC) and comparatively good ductility as well as high demands for wear resistance (abrasive/adhesive/galling/fretting). With a composition according to the table, the steel has a matrix, which after hardening from an austenitizing temperature of 1080 and low temperature tempering at 200 to 450° C., 2×2 h, or high temperature tempering at 450 to 700° C., 2×2 h, consists of tempered martensite with a hard phase amount consisting of up to about 3 to 15 vol.-% of M₂X, where M mainly is Cr and V, and X mainly is N, and 15 to 25% of MX, where M mainly is V, and X mainly is N.

Table 7 shows the composition ranges in weight-% for a steel according to an additional, preferred embodiment of the invention.

TABLE 7

| | Element | | | | | | |
|---|---|---|---|---|---|---|---|
| | C | Si | Mn | Cr | Mo | V | N |
| Min. | 0.10 | 0.01 | 0.01 | 30.0 | 0.01 | 7.5 | 4.0 |
| Guideline value | 0.20 | 0.30 | 0.30 | 32.0 | 1.3 | 9.0 | 5.6 |
| Max. | 1.5 | 1.5 | 1.5 | 33.0 | 2.5 | 11 | 7.0 |

Within the scope of the idea of the invention, it is also conceivable to allow vanadium contents of up to about 10%, which, in combination with vanadium contents of up to about 14% and carbon contents in the range 0.1 to 2%, gives the steel the desired properties, especially at use for wear surfaces with high requirements for corrosions resistance in combination with high hardness (up to 60 to 62 HRC) and a moderate ductility as well as extremely high requirements for wear resistance (abrasive/adhesive/galling/fretting). The steel according to said embodiment has a matrix, which after hardening from an austenitizing temperature of about 1100° C. and low temperature tempering at 200 to 450° C., 2×2 h, or high temperature tempering at 450 to 700° C., 2×2 h, consists of tempered martensite with a hard phase amount consisting of up to about 2 to 15 vol.-% of M₂X, where M mainly is Cr and V, and X mainly is N, and 15 to 25% of MX, where M mainly is V, and X mainly is N.

The steel according to the embodiments described above has proved to be suitable for use for wear surfaces of products which are subjected to a great mixed adhesive and abrasive wear, especially galling and fretting. It also has high hardness and a very good corrosion resistance, and therefore it is suitable to use for wear surfaces of products within the food industry, offshore industry and other products subjected to corrosion, e.g. injection nozzles for engines, components in bearings, etc. As the wear resistant steel material is comparatively hard and brittle, it comparatively badly withstands the loads arising at screw connections. By using the steel material in a compound product, a product is obtained, where the substrate is responsible for the product fulfilling other requirements, which the wear material does not fulfil, e.g. the necessary ductility, hot workability and machinability. Examples of such products are valves, wear components in pumps, wear bodies and other complex components which are subjected to wear.

At the hot working of compound products, the wear resistant material is austenitized at a temperature between 950 and 1150° C., preferably between 1020 and 1130° C., most preferred between 1050 and 1120° C. Higher austenitizing temperatures are in principle conceivable but are unsuitable with regard to the fact that the hardening furnaces normally existing are not adapted to higher temperatures. A suitable holding time at the austenitizing temperature is 10 to 30 min. From said austenitizing temperature the steel is cooled to room temperature or lower, e.g. to −40° C. To eliminate retained austenite in order to give the product the desired dimensional stability, deep freezing may be practised, which is suitably performed in dry ice to about −70 to −80° C. or in liquid nitrogen at about −196° C. To obtain an optimal corrosion resistance, the tool is low temperature tempered at 200 to 300° C. at least once, preferably twice. If the steel instead is optimized in order to obtain a secondary hardening, the product is high temperature tempered at least once, preferably twice, and possibly several times at a temperature between 400 and 560° C., preferably at 450 and 525° C. The product is cooled after each such tempering treatment. Preferably, also in this case deep freezing is used as mentioned above in order further to ensure a desired dimensional stability by eliminating possibly remaining retained austenite. The holding time at the tempering temperature may be 1 to 10 h, preferably 1 to 2 h. The composition of the wear resistant steel material gives a very good tempering response.

In connection with the different hot workings, which the wear resistant steel material is subjected to, for instance at the hot isostatic pressing in order to form a compacted compound product, and at the hardening of the finished compound product, adjacent carbides, nitrides and/or carbonitrides in the wear resistant steel material may coalesce and form large agglomerates. The size of said hard phase particles in the wear layer of the finished, heat treated product may therefore exceed 3 μm. The main part expressed in vol.-% is in the range 1 to 10 μm in the longest extension of the particles and the average size of the particles is below 1 μm. The total amount of hard phase is dependent on the nitrogen content and the amount of nitride formers, i.e. mainly vanadium and chromium. Generally, the total amount of hard phase in the wear layer of the finished product is in the range 5 to 40 vol.-%.

The powder of the wear resistant steel material is manufactured by disintegration of a melt with the indicated composition, except for nitrogen, for the wear resistant steel material. Inert gas, preferably, nitrogen, is blown through a jet of the melt which is split into droplets which are allowed to solidify, and subsequently the powder obtained is subjected to solid phase nitriding to the desired nitrogen content.

### Performed Experiments

Preparation of Specimens

Stellite 6 and Skwam were applied on a surface region of a disc-shaped substrate through welding-on with four layers. The total thickness of the applied layer was 5 mm. Then, the very surfaces of the specimens were ground and polished to a surface finish necessary for valves, i.e. Ra˜0.05 μm. The weld coated surfaces had small pores also after the polishing, which could be seen with the naked eye.

After weld coating, Stellite 6 and Skwam has a hardness of 42 HRC according to the data specification from the manufacturers, and this was confirmed at the laboratory measurement.

Test rods of Vanax 75, a powder metallurgically produced steel with a composition within the intervals indicated in claim 1, was cut from a hit isostatic pressed body and then ground and polished to the same surface finish as the alloys applied by welding.

The test bars of Vanax 75 were heat treated in a vacuum furnace with the use of nitrogen gas as the quenching medium. The hot working cycle used was austenitizing at an austenitizing temperature, T_{A}=1080° C. during 30 min followed by deep freezing in liquid nitrogen and tempering twice at a tempering temperature of 400° C. during two hours (2×2 h).

Chemical Composition

The aimed values of the chemical compositions in weight-% of the alloys used in the test program are shown in Table 6.

TABLE 6

| Alloy | Alloy base | C | N | Si | Mn | Cr | Ni | Mo | W | V | Fe | Co |
|---|---|---|---|---|---|---|---|---|---|---|---|---|
| Stellite 6 | Co | 1.3 | — | 1.1 | 0.1 | 30 | 2.3 | 0.1 | 4.7 | — | 2.5 | balance |
| Skwam | Fe | 0.2 | — | 0.4 | 0.4 | 17 | — | 1.3 | — | — | balance | — |
| Vanax 75 | Fe | 0.2 | 4.3 | 0.3 | 0.3 | 21 | — | 1.3 | — | 9 | balance | — |

Wear Resistance

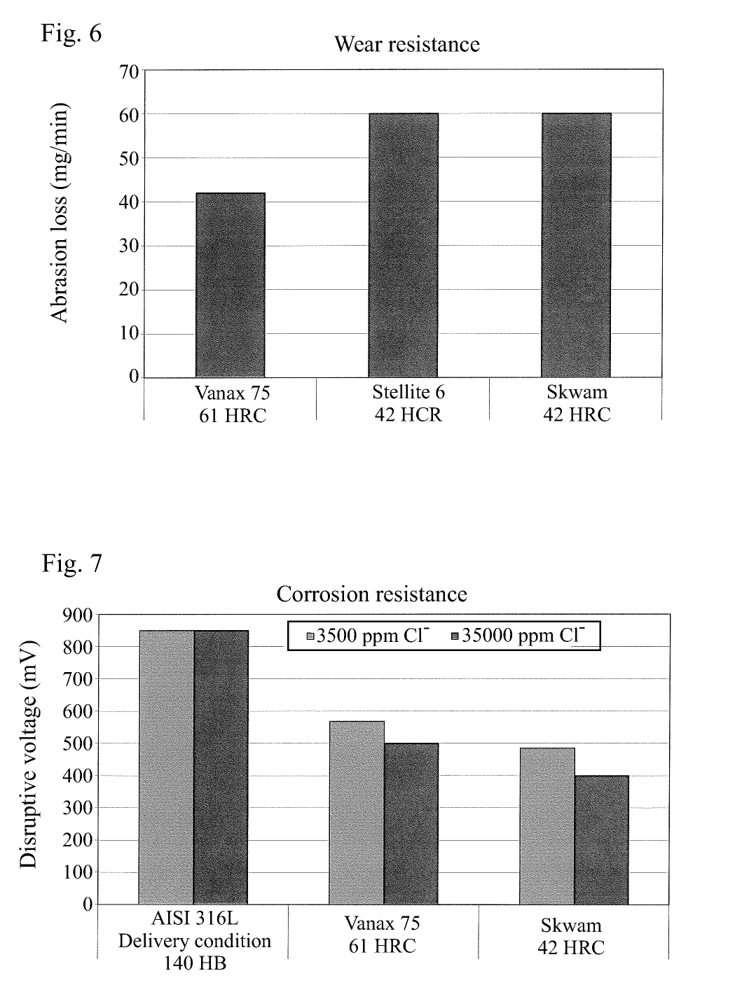

The wear resistance was determined with use of a pin-to-disc-test A grinding paper with Al₂O₃ (1500 mesh) was used at the test and the pressure at the test was 0.4 MPa. The abrasion loss in mg/min for the three tested alloys is shown in FIG. 6. From the figure it may be seen that the wear resistant steel material of the invention, Vanax 75, has a considerably much better wear resistance than the two comparison materials Stellite 6 and Skwam.

Corrosion Resistance

The corrosion resistance of AISI 316L, Vanax 75, and Skwam was examined by use of a standardized cyclic polarisation method according to ASTM 76 to determine the break down potential of the oxide layer of the alloys in a water solution containing 3500 or 35000 ppm Cl⁻. All tests were performed at room temperature. FIG. 7 shows the corrosion resistance as the break down potential in mV in water containing chloride. For each alloy two bars are shown side by side. The left bar shows the result at a chloride content of 3500 ppm Cl⁻ while the right one relates to ten times as high a content, 35000 ppm Cl⁻. All tests were performed at room temperature, and a higher value indicates better corrosion resistance. The figure shows that Vanax 75 has a better corrosion resistance than Skwam but worse than AISI 316L. It shall, however, be pointed out that for AISI 316L there is a certain dispersion which seems to be connected to the size of the steel and how it has been treated. Practical experiments have showed break down potentials down to 600 mV.

Hardness

After coating by welding, Stellite 6 and Skwam have a hardness of 42 HRC. The test bars of Vanax 75 have a hardness of 61 HRC after hardening and low temperature tempering according to the above.

Microstructure

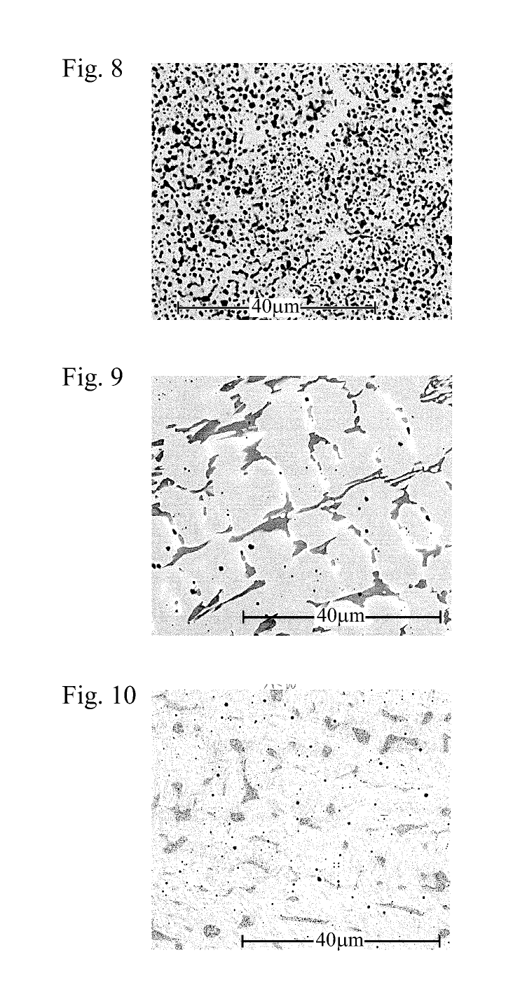

The microstructure of Vanax 75 consists of a martensitic matrix and 23 vol.-% of a hard phase of MX-type, where M is V, and X is N and C. The hard phase particles has an average size below 3 μm, preferably below 2 atm, and even more preferred below 1 μm. The hard phase particles are homogeneously distributed in the matrix, see FIG. 8.

After coating by welding the microstructure of Stellite 6 consists of a dendritic, austenitic cobalt matrix and a high volume fraction of comparatively very coarse elongated chromium carbides. The chromium carbides occur in the dendritic regions of retained melt and are thus very unevenly distributed in the matrix, see FIG. 9.

After coating by welding the microstructure of Skwam consists of a martensitic matrix with inter-dendritic chromium carbides. The coarse agglomerates of chromium carbides are unevenly distributed in the matrix, see FIG. 10.

Friction Properties

The friction properties of the steel materials are of great importance for certain applications, e.g. for valves, as they influence the energy consumption of the engines as well as influence which type of engines may be used for the adjustment means of the valves. Electric engines manage lower loads while larger loads require pneumatically or hydraulically controlled adjustment means. This influences in its turn the choice of equipment.

The friction properties are influenced by the anti-galling properties of the steel and these were tested by pin on disc tests, wherein a test bar of a steel material is placed against a rotating disc of another or the same steel material. The tests were performed in deionized water at a temperature of 80° C., max. contact pressure=720 Mpa, surface finish, Ra˜0.02 μm, relative sliding speed=0.02 m/s, test time/test length=1000 s/20 min.

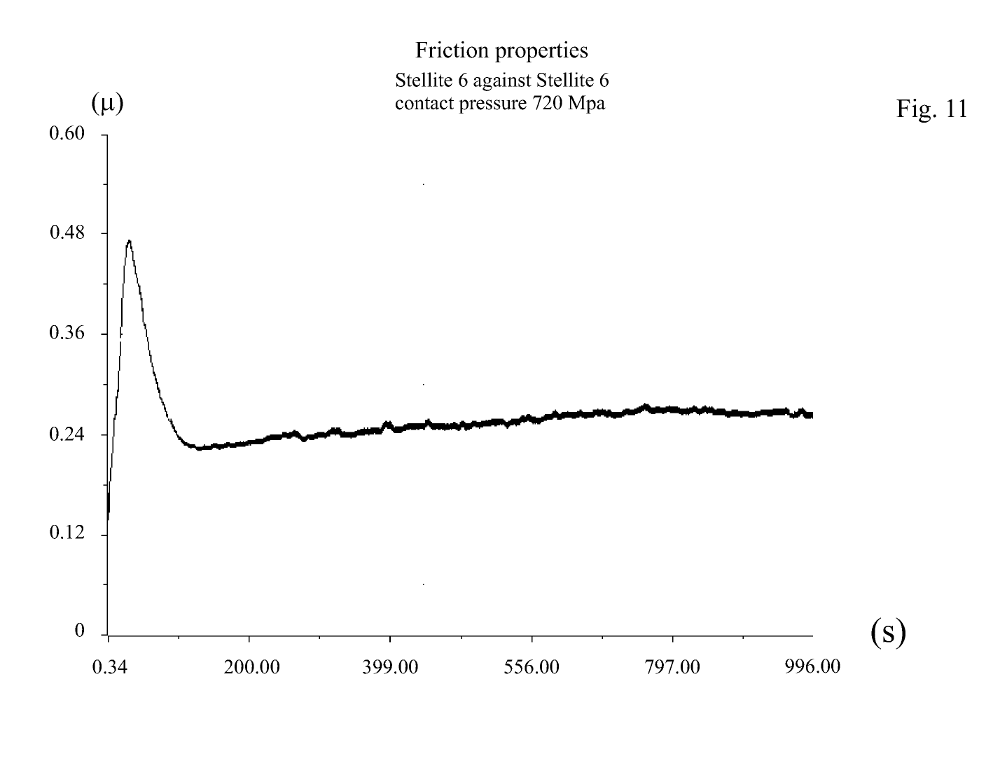

The result of the pin on disc test of Stellite 6 to Stellite 6 is shown in FIG. 11. Initially, the friction increases, then it decreases and ends at an even level, μ about 0.25, which confirms the effect of the kind initially described.

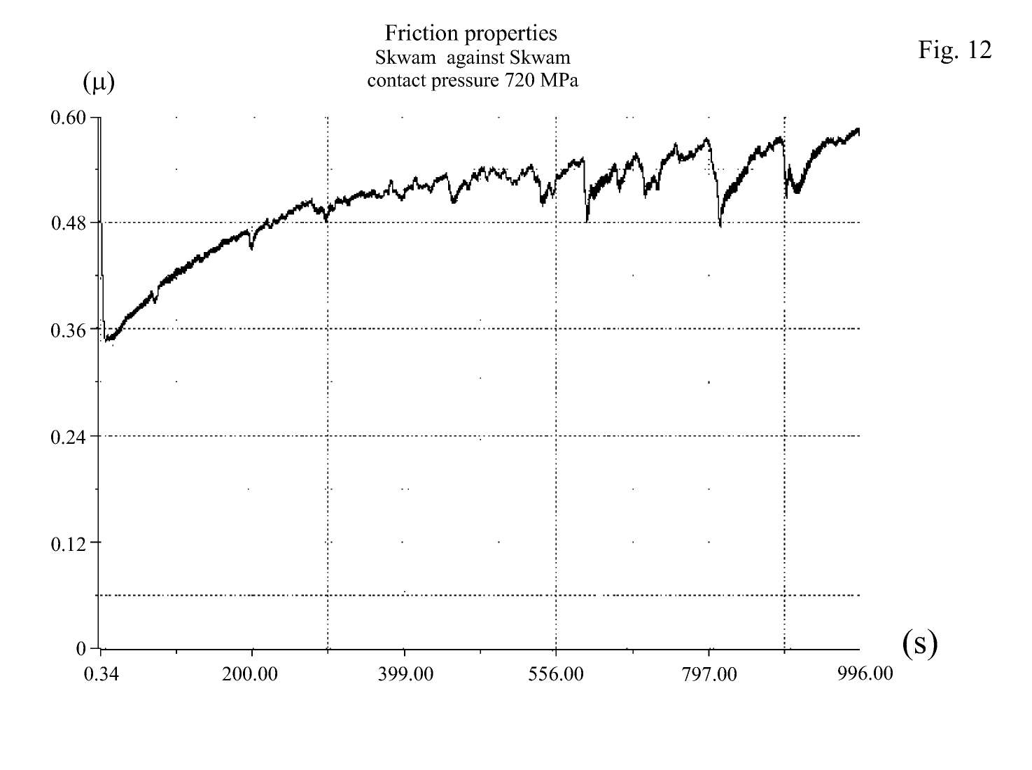

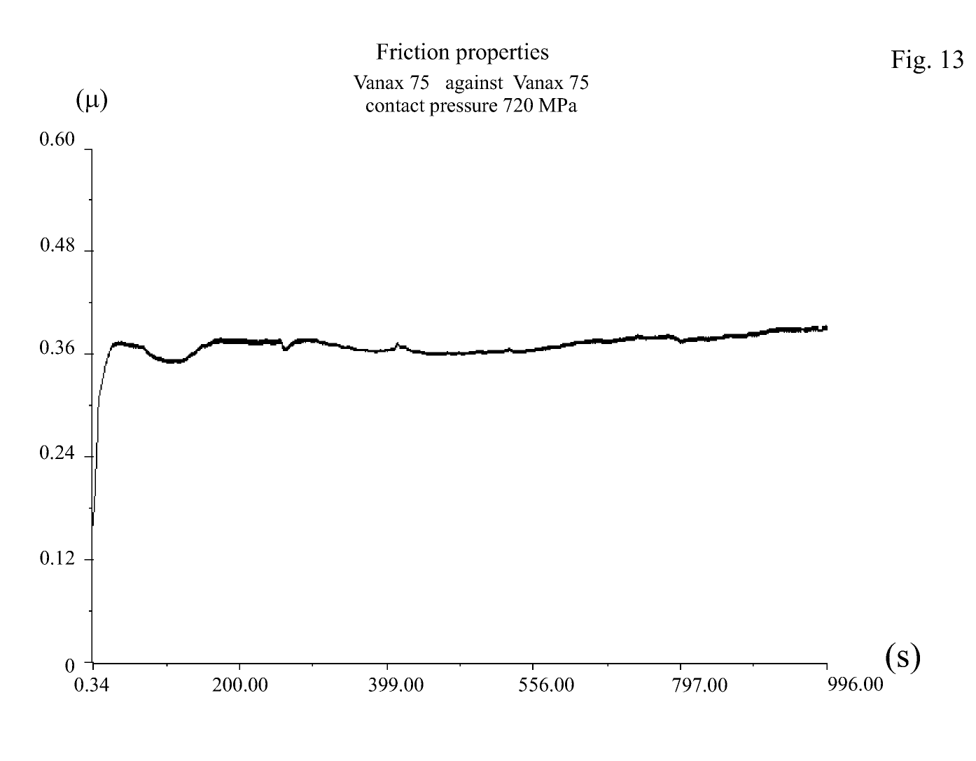

FIG. 12 shows the friction properties when two surfaces of Skwam are tested towards each other. As may be seen, a gradually increasing friction coefficient is obtained during the pin on disc test, which depends on alternating cold welding and release between the materials.

The friction properties when two surfaces of Vanax 75 were tested against each other are shown in FIG. 13. This material shows good friction properties on an even level, about 0.36, which may be attributed to the even distribution of very fine and hard hard phase particles.

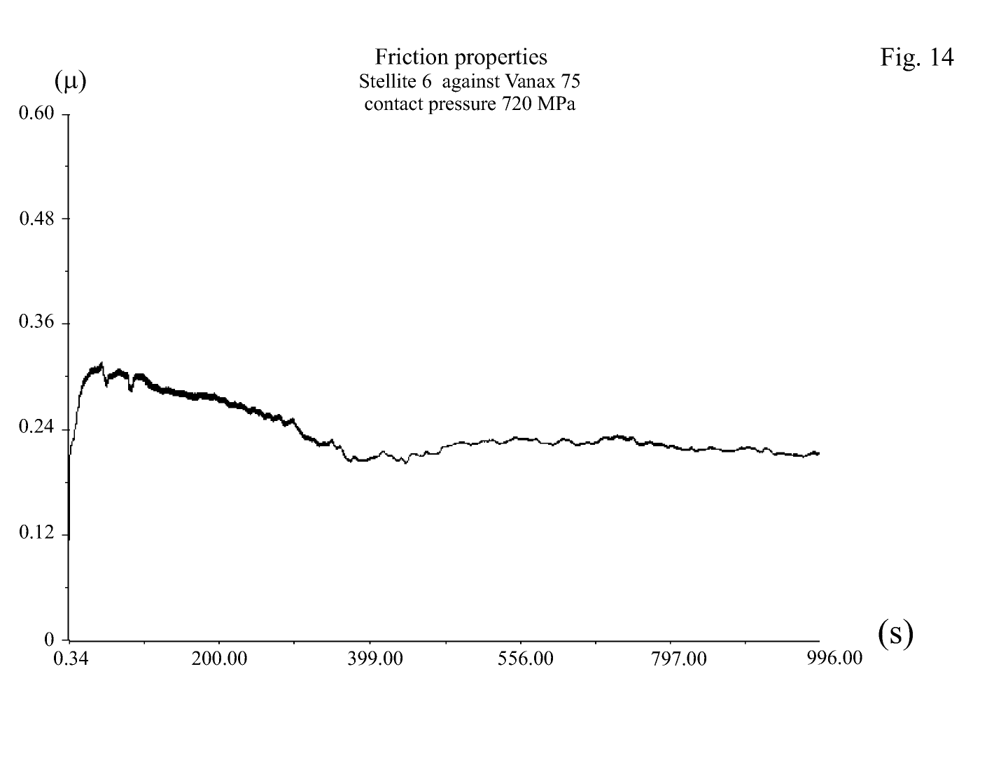

Finally, a surface of Stellite 6 as compared to a surface of Vanax 75 was tested. The result is shown in FIG. 14. Initially a certain small increase of the friction coefficient is obtained, essentially much smaller than when the two wear surfaces consisted of Stellite 6, and then the friction coefficient decreases and ends at a level of about 0.22, i.e. better than when Stellite 6 is used for both contact surfaces. This is very remarkable and shows that the friction may be kept at a feasible lower level which enables the use of electrically driven equipment, which gives a greater flexibility than with pneumatic and hydraulic equipment.

Tempering Response

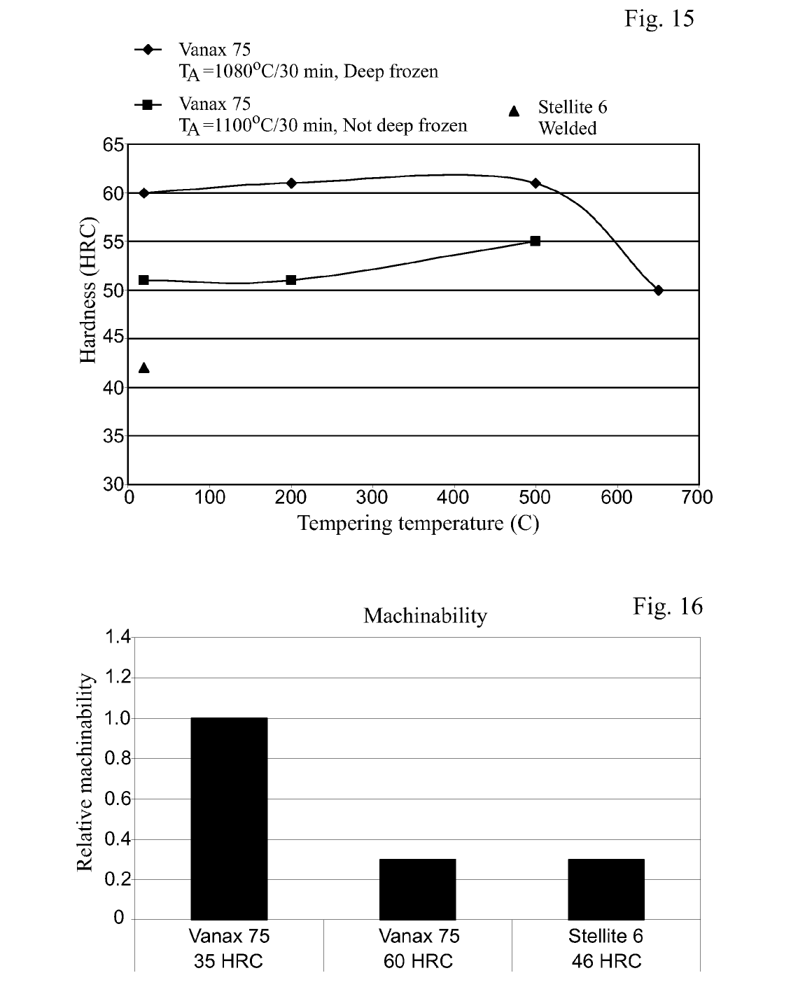

The tempering response of the wear resistant steel material, Vanax 75, was tested. The result is shown in FIG. 15 and proves that the wear resistant steel material has a very good tempering response. For Vanax 75 in deep frozen condition, a hardness of 60 to 62 HRC is obtained at tempering up to about 500° C. Thereafter the hardness decreases but nevertheless a hardness is obtained which well exceeds the hardness which may be achieved with Stellite 6, the hardness of which is about 42 HRC, independent of tempering temperature. Vanax 75 in non-deep frozen condition shows a good tempering response and obtains a hardness of 51 to 55 HRC.

High Temperature Resistance

The high temperature resistance of the wear resistant steel material was examined by studying how the hard phase particles were influenced at heating to different temperatures up to about 1300° C. It could be determined that the hard phase particles were very stable. In principle, none or very little growth of hard phase particles took place, in spite of the high temperatures used. This is very advantageous if the material is to be used at high operation temperatures (700 to 800° C.) and long operation periods. As examples, steam or gas turbine plants within the power industry may be mentioned, where the operation takes places at very high temperatures and in addition during extremely long operation periods, up to 60 years for such a plant.

Machinability

The machinability of the wear resistant steel material according to the invention was examined and compared with Stellite 6. The machinability of Vanax 75 in delivery condition, i.e. hot isostatic soft annealed condition (35 HRC), and in hardened and tempered condition (60 HRC) was examined, while the machinability of Stellite 6 was examined in the delivery condition (46 HRC) of that material. The machinability of Vanax 75 in delivery condition was used as a reference value. FIG. 16 shows that Vanax 75 in hardened and tempered condition and Stellite 6 have comparable machinability (about 0.30). Application tests have also shown that Vanax 75 in hardened and tempered condition has a somewhat better machinability than Stellite 6. Vanax 75 in delivery condition has the best machinability (1.0).

Discussion

The results from the tests described above show that a wear resistant surface layer with a composition according to claim 1 may very successfully be applied on a metallic substrate without any risk that the substrate is locally depleted of corrosion retarding alloy elements. The binding of the two materials suitably takes place by hot isostatic pressing. At the hot isostatic pressing the wear resistant steel material and the substrate, respectively, may consist of:
a) a powder and a solid material, respectively;
b) a powder and a powder, respectively, with or without a barrier layer; or
c) a solid material and a solid material, respectively.

The product obtained is especially suitable for use for components which are subjected to hard surface pressures, i.e. in applications subjected to wear where abrasive wear and wear due to cold welding between the components, so called galling, are especially distinct. Thanks to the wear resistant steel material also having a very good corrosion resistance, it may advantageously be used within the offshore industry, food industry, processing industry and pulp industry, where also corrosion resistance is required for instance in valves, pumps and attachments devices. With the manufacturing method of the invention it has proved possible to produce a compound product which is especially suitable for use as a valve to adjust flows of steam and water in the primary circuit of a nuclear power plant, and it seems possible to replace today's valves containing a wear surface of the cobalt based alloy Stellite 6. This implies another advantage. Thanks to the wear resistant steel material not containing any cobalt, today's problem of an increased level of the background radiation in the primary circuit in the boiling water reactors may be avoided. It has also proved that the steel material of the invention has excellent friction properties and it seems possible to provide products which contribute to reduce the energy consumption and enable use of electrically driven control equipment which gives a greater flexibility than when pneumatic and hydraulic components have to be used.

1. A method for the manufacture of a compound product comprising a substrate of a first metallic material giving the product the necessary strength/resistance, and a coating of wear resistant steel material applied on a surface region of the substrate, comprising:
producing a wear resistant steel material in a powder metallurgical manner with the following composition in weight-%:

| C | Si | Mn | Cr | Ni | Mo + ½W | Co | S | N |
|---|---|---|---|---|---|---|---|---|
| 0.01-2 | 0.01-3.0 | 0.01-10.0 | 16-33 | max. 5 | 0.01-5.0 | max. 9 | max. 0.5 | 0.6-10 |

and, further,
0.5 to 14 of (V+Nb/2), wherein the contents of N, on one hand, and of (V+Nb/2), on the other hand, are balanced in relation to each other so that the contents of said elements are within an range A′, B′, G, H, A′ in a perpendicular, plane coordinate system, where the content of N is the abscissa and the content of V+Nb/2 is the ordinate, and where the coordinates for said points are:

| | A′ | B′ | G | H |
|---|---|---|---|---|
| N | 0.6 | 1.6 | 9.8 | 2.6 |
| V + Nb/2 | 0.5 | 0.5 | 14.0 | 14.0 |

and
max 7 of any of Ti, Zr, and Al;
balance essentially only iron and unavoidable impurities;
applying the wear resistant steel material on said surface region of the substrate; and
hot isostatic pressing of the substrate with the coating to a completely dense or at least close to completely dense body.

2. A method according to claim 1, further comprising:
encasing of the substrate with the coating in a capsule;
evacuating gas in the capsule, and after the hot isostatic pressing;
removing the capsule or at least part of the capsule covering the wear resistant steel material.

3. A method according to claim 2, wherein an insert of the first metallic material is placed into the capsule, and powder of the wear resistant steel material is applied on said surface region of the insert, and thereafter the capsule is sealed.

4. A method according to claim 1, wherein powder of the wear resistant steel material is applied on a surface region of an insert of the first metallic material, which insert has at least to some extent been completely machined, and that a hood-like capsule is arranged to encase said powder and to be welded towards the sides of the insert.

5. A method according to claim 2, wherein an intermediate product of the wear resistant steel material is manufactured by binding the powder granules in the powder of the wear resistant steel material, and this intermediate product is applied on an insert of the first metallic material, and subsequently the unit obtained is encased in the capsule.

6. (canceled)

7. A method according to claim 5, wherein the powder granules are bound by hot isostatic pressing.

8. A method according to claim 2, wherein the two steel materials are kept apart by a capsule wall to avoid a detrimental diffusion of easily movable alloy elements, e.g. C or N, between the wear resistant steel material and the first metallic material.

9. A method according to claim 8, wherein the capsule wall mainly consists of nickel or a monel metal.

10. A method according to claim 2, wherein also the first metallic material consists of a powder which is placed into said capsule.

11. A method according to claim 2, wherein said capsule is a first capsule, that a second capsule is filled with powder of the first metallic material, i.e. the substrate, and the second capsule is sealed and placed into the first capsule, that powder of the wear resistant steel material is filled into the second capsule so that it is arranged towards the capsule wall in connection to at least said surface region of the substrate, and subsequently the first capsule is sealed.

12. A method according to claim 1, wherein a powder of the wear resistant steel material is manufactured by disintegration of a melt with the composition indicated for the wear resistant steel material, except for nitrogen, said disintegration being performed by inert gas, preferably nitrogen, being blown through a jet of the melt which is split into droplets which are allowed to solidify, and subsequently the powder obtained is subjected to solid phase nitriding to the indicated nitrogen content.

13. (canceled)

14. A method according to claim 1, further comprising:
soft annealing, machining to the desired dimensions and heat treatment, said heat treatment being performed by hardening from an austenitizing temperature of 950 to 1150° C. and low temperature tempering at 200 to 450° C., 2×2 h, or high temperature tempering at 450 to 700° C., 2×2 h.

15. A method according to claim 1, wherein the coating has a thickness of 0.5 to 1000 mm, preferably 0.5 to 50 mm, even more preferred 0.5 to 30 mm, yet even more preferred 0.5 to 10 mm and most preferred 3 to 5 mm.

16. (canceled)

17. (canceled)

18. (canceled)

19. (canceled)

20. (canceled)

21. (canceled)

22. A compound product comprising a substrate of a first metallic material giving the product the necessary strength/resistance, and a coating of wear resistant steel material applied on a surface region of the substrate, wherein the wear resistant steel material comprises a substrate for a wear surface, where the substrate has a first composition, and wherein the wear surface comprises a wear resistant steel material with a second composition, which comprises, in weight-%:

| C | Si | Mn | Cr | Ni | Mo + W/2 | Co | S | N |
|---|---|---|---|---|---|---|---|---|
| 0.01-2 | 0.01-3.0 | 0.01-10.0 | 16-33 | max. 5 | 0.01-5.0 | max. 9 | max. 0.5 | 0.6-10 |

and, further,
0.5 to 14 of (V+Nb/2), wherein the contents of N, on one hand, and of (V+Nb/2), on the other hand, are balanced in relation to each other so that the contents of said elements are within an range A′, B′, G, H, A′ in a perpendicular, plane coordinate system, where the content of N is the abscissa and the content of V+Nb/2 is the ordinate, and where the coordinates for said points are:

| | A′ | B′ | G | H |
|---|---|---|---|---|
| N | 0.6 | 1.6 | 9.8 | 2.6 |
| V + Nb/2 | 0.5 | 0.5 | 14.0 | 14.0 |

and
max 7 of any of Ti, Zr, and Al;
balance essentially only iron and unavoidable impurities;
the steel material has a microstructure comprising an even distribution of up to 50 vol.-% of hard phase particles of M₂X-, MX- and or M₂₃C₆/M₇C₃-type, the size of which in their longest extension is 1 to 10 μm, where the content of said hard phase particles is such that up to 20 vol.-% are M₂X-carbides, -nitridies and/or -carbonitries, wherein M mainly is Cr, and X mainly is N, and 5 to 40 vol.-% of MX-carbides, -nitrides and/or -carbonitrides, wherein M mainly is V and Cr, and X mainly is N, wherein the average size of said MX-particles is below 3 μm, preferably below 2 μm, and even more preferred below 1 μm.

23. A compound product according to claim 22, wherein
the wear resistant steel material is applied on the substrate by hot isostatic pressing, wherein a compacted product is obtained;
the compacted product is machined to the desired dimensions;
it is heat treated by hardening from an austenitizing temperature of 950 to 1500° C. and low temperature tempering at 200 to 450° C., 2×2 h, or high temperature tempering at 450 to 700° C., 2×2 h; and
in that the metallic material of the substrate withstands hot isostatic pressing at 1100 to 1150° C. and is compatible with the wear resistant steel material as to hot working.

24. A compound product according to claim 22, wherein the following elements are included in the wear resistant steel material, contents in weight-%:

| | Element | | | | | | |
|---|---|---|---|---|---|---|---|
| | C | Si | Mn | Cr | Mo | V | N |
| Min. | 0.10 | 0.01 | 0.01 | 18.0 | 0.01 | 2.0 | 1.3 |
| Guideline value | 0.20 | 0.30 | 0.30 | 21.0 | 1.3 | 2.85 | 2.1 |
| Max. | 0.50 | 1.5 | 1.5 | 21.5 | 2.5 | 4.0 | 3.0 |

and preferably in that the content of V is between 2.5 and 3.0 weight-% and the content of N between 1.3 and 2.0 weight-%.

25. (canceled)

26. A compound product according to claim 22, wherein the following elements are included in the wear resistant steel material, contents in weight-%:

| | Element | | | | | | |
|---|---|---|---|---|---|---|---|
| | C | Si | Mn | Cr | Mo | V | N |
| Min. | 0.10 | 0.01 | 0.01 | 18.0 | 0.01 | 7.5 | 2.5 |
| Guideline value | 0.20 | 0.30 | 0.30 | 21.0 | 1.3 | 9.0 | 4.3 |
| Max. | 1.5 | 1.5 | 1.5 | 21.5 | 2.5 | 11 | 6.5 |

and preferably in that in the wear resistant steel material, carbon is present in a content of 0.1 to 2 weight-%, nitrogen in a content of up to about 10 weight-%, and vanadium in a content of up to about 14 weight-%.

27. (canceled)

28. (canceled)

29. A compound product according to claim 23, wherein it consists of a component in a valve, which is subjected to wear, and that the material of the substrate consists of a steel for pressure vessels.

30. A compound product according to claim 29, wherein the wear resistant steel is void of intentionally added cobalt and forms a wear surface of a component in a valve in a nuclear power plant, which component is subjected to wear, wherein the material of the substrate has a composition corresponding to AISI 316L.

31. A compound product according to claim 23, wherein it is a wear component, pump part, engine component, roller or another components with a wear surface of the wear resistant material, and, that in such an application, the entire component does not consist of the wear resistant steel material.

32. A compound product according to claim 22, wherein the coating has a thickness of 0.5 to 1000 mm, preferably 0.5 to 50 mm, even more preferred 0.5 to 30 mm, yet even more preferred 0.5 to 10 mm and most preferred 3 to 5 mm.

33. (canceled)

34. Use of a steel material produced in a powder metallurgical manner with the following composition in weight-%:

| C | Si | Mn | Cr | Ni | Mo + ½W | Co | S | N |
|---|---|---|---|---|---|---|---|---|
| 0.01-2 | 0.01-3.0 | 0.01-10.0 | 16-33 | max. 5 | 0.01-5.0 | max. 9 | max. 0.5 | 0.6-10 |

and, further,
0.5 to 14 of (V+Nb/2), wherein the contents of N, on one hand, and of (V+Nb/2), on the other hand, are balanced in relation to each other so that the contents of said elements are within a range A′, B′, G, H, A′ in a perpendicular, plane coordinate system, where the content of N is the abscissa and the content of V+Nb/2 is the ordinate, and where the coordinates for said points are:

| | A′ | B′ | G | H |
|---|---|---|---|---|
| N | 0.6 | 1.6 | 9.8 | 2.6 |
| V + Nb/2 | 0.5 | 0.5 | 14.0 | 14.0 |

and
max 7 of any of Ti, Zr, and Al;
balance essentially only iron and unavoidable impurities;
for obtaining a wear resistant surface region on a substrate of a metallic material with another, first composition, wherein said surface region preferably is a wear surface of a valve, preferably a valve in a nuclear power plant and even more preferred a valve in the primary circuit of a nuclear power plant.

35. (canceled)
